(19) United States
(12) Patent Application Publication
(10) Pub. No.: US 2008/0062570 A1
(43) Pub. Date: Mar. 13, 2008

(54) Storage

(75) Inventor: Hideaki Kamezawa, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/789,084

(22) Filed: Apr. 23, 2007

(30) Foreign Application Priority Data
Sep. 12, 2006 (JP) 2006-246446

(51) Int. Cl. G11B 5/48

(52) U.S. Cl. 360/245.3

(57) ABSTRACT

A carriage arm supports a head gimbal assembly that includes a head that records information in and/or reproduces the information from a recording medium. The carriage arm has a perforation hole filled with resin near a center part.

This application claims the right of foreign priority under 35 U.S.C. §119 based on Japanese Patent Application No. 2006-246446, filed on Sep. 12, 2006, which is hereby incorporated by reference herein in its entirety as if fully set forth herein.

### BACKGROUND OF THE INVENTION

The present invention relates generally to a storage, and more particularly to a carriage that supports a head and moves it to a target position on a disc, and a method of manufacturing the same. The present invention is suitable, for example, for a manufacturing method of a head carriage used for a hard disc drive (“HDD”).

The HDD typically includes one or more discs, a voice coil motor (“VCM”), and a head stack assembly (“HSA”). The HSA includes a carriage (also referred to as an “actuator,” an “E-block” due to its E-shaped section or “actuator (“AC”) block”) which is pivoted around a shaft by the VCM, a suspension attached to a support portion of the carriage (which is referred to as an “arm” hereinafter), and a magnetic head part supported on the suspension. The magnetic head part includes a fine head core (simply referred to as a “head” hereinafter) that records and reproduces a signal, and a slider that supports the head.

The HDD is required to quickly and precisely position the head to a target track. Since a reduction of the inertia moment of the arm is effective to the quick movement of the head, it is conceivable to partially form a perforation hole in the arm. However, the airflow associated with the disc's rotations enters the perforation hole and vibrates the slider or the disc. A vibration of the disc is referred to as a flutter. The vibration lowers the positioning accuracy of the head. In particular, the recent high-speed rotations of the disc increases the airflow speed of the disc and the high recording density of the disc narrows a track pitch, remarkably lowering the head's poisoning accuracy. Conventionally, a pair of metal plates are manually adhered to the front and back surfaces of the arm around the perforation hole to seal it and to prevent the airflow from entering it.

Prior art include, for example, PCT International Publication WO 2004/040572 and Japanese Patent Application Publication No. 2005-190511.

It is arduous to join the metal plates with both front and back surfaces of the arm because of a narrow interval between a pair of adjacent arms. In addition, it is necessary for a faster movement of the head to reduce the arm's inertia moment.

### BRIEF SUMMARY OF THE INVENTION

The present invention provides a carriage arm that can be easily manufactured and more quickly moved and a storage having the same.

According to one aspect of the present invention, a carriage arm that supports a head gimbal assembly that includes a head that records information in and/or reproduces the information from a recording medium has a perforation hole near a center part, and includes resin filled in the perforation hole. This carriage arm has the perforation hole filled with resin, prevents the airflow from entering the perforation hole, and can move quickly because the resin is lighter than the metal plate. Since resin sealing can be automated, the operability improves.

A storage according to another aspect of the present invention includes a head gimbal assembly that includes a head that records information in and/or reproduces the information from a recording medium, and a carriage that rotates around a shaft, and includes an arm that supports the head gimbal assembly, the arm having a perforation hole with resin near a center part. The storage may further include a voice coil motor that rotates the carriage, the voice coil motor including a coil block that is molded with the resin and opposes to the arm with respect to the shaft of the carriage, and a voice coil mounted on the coil block. Due to use of the same resin for the coil block and the sealing material for the perforation hole, the same molding machine can be used for the cost reduction. When the voice coil is molded with the resin, the same molding machine can be conveniently used.

A method for manufacturing a carriage for a storage, which has an arm that supports a head gimbal assembly that includes a head that records information and/or reproduces the information from a recording medium includes the steps of forming a perforation hole near a center part in the arm, and molding a coil block mounted with a voice coil of a voice coil motor that rotates the arm around a shaft and sealing the perforation hole with the same resin. This manufacturing method uses the same molding machine and the same resin to mold the coil block and to seal the perforation hole, improving the manufacture efficiency and the cost down. The carriage arm having the perforation hole filled with resin can move faster than the conventional one that uses the metal plate.

In this case, the molding and sealing step simultaneously performs molding of the coil block and sealing of the perforation hole for the improved throughput. The carriage may include plural arms, each of which has the perforation hole, and the molding and sealing step may seal the resin in plural perforation holes and between the plural perforation holes, and wherein the method may further include the step of removing the resin between the plural perforation holes. Thereby, the operation becomes easier then filling resin in the perforation hole one by one.

Other objects and further features of the present invention will become readily apparent from the following description of preferred embodiments with reference to the accompanying drawings.

### BRIEF DESCRIPTION OF THE DRAWINGS

FIG. 1 is a plane view of a HDD according to one aspect of the present invention.

FIG. 2 is a schematic enlarged perspective view of a magnetic head part shown in FIG. 1.

FIG. 3A is a plane view of a carriage shown in FIG. 1, and FIG. 3B is its side view.

FIG. 4A is a plane view of a conventional carriage, FIG. 4B is its side view, and FIG. 4C is a schematic partially enlarged section of FIG. 4B.

FIG. 5 is a graph showing a relationship between the arm's inertia moment and the head access time period.

FIGS. 6A and 6B are flowcharts for explaining principal part of a manufacturing method of the carriage shown in FIG. 1.

FIGS. 7A and 7B are plane and side views of one step shown in FIG. 6B.

FIGS. 8A and 8B are plane and side views of another step shown in FIG. 6B.

### DETAILED DESCRIPTION OF THE PREFERRED EMBODIMENTS

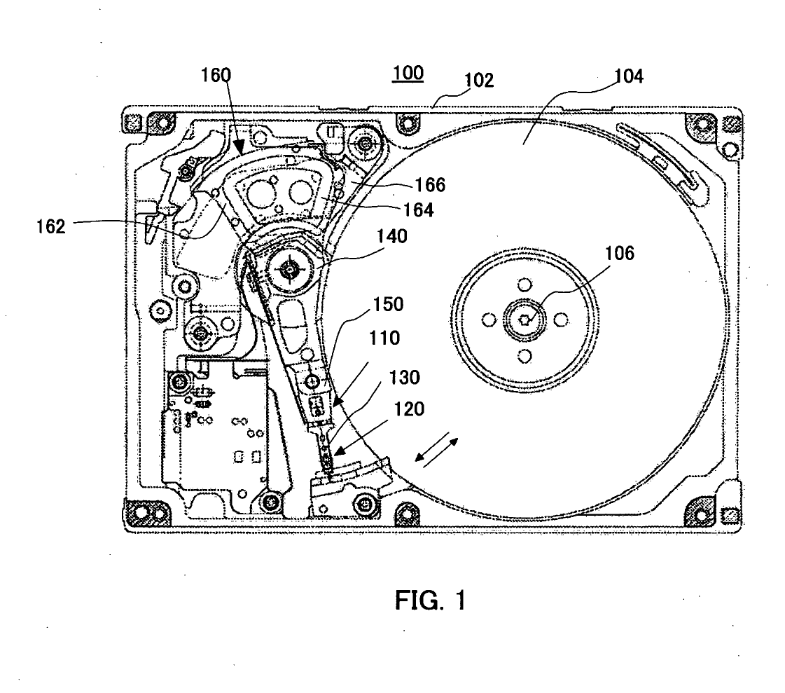

Referring now to the accompanying drawings, a description will be given of an HDD 100 according to one embodiment of the present invention. The HDD 100 includes, as shown in FIG. 1, plural magnetic discs 104 each serving as a recording medium, a spindle motor 106, a HSA 110, and a VCM 160 in a housing 102. Here, FIG. 1 is a schematic plane view of the internal structure of the HDD 100.

The housing or base 102 is made, for example, of aluminum die cast and stainless steel, and has a rectangular parallelepiped shape joined with a cover that seals the internal space. The magnetic disc 104 has a high surface recording density, such as 100 Gb/in² or greater. The magnetic disc 104 is mounted on a spindle (hub) of the spindle motor 106 through its center hole of the magnetic disc 104.

The spindle motor 106 has, for example, a brushless DC motor (not shown) and a spindle as its rotor part. For instance, two magnetic discs 104 are used in order of the disc, a spacer, the disc and a clamp stacked on the spindle, and fixed by bolts coupled with the spindle.

The HSA 110 includes a magnetic head part 120, a suspension 130, a carriage 140, and a base plate 150.

The magnetic head part 120 includes a slider 121, and a head device built-in film 123 that is jointed with an air outflow end of the slider 121 and has a read/write head 122.

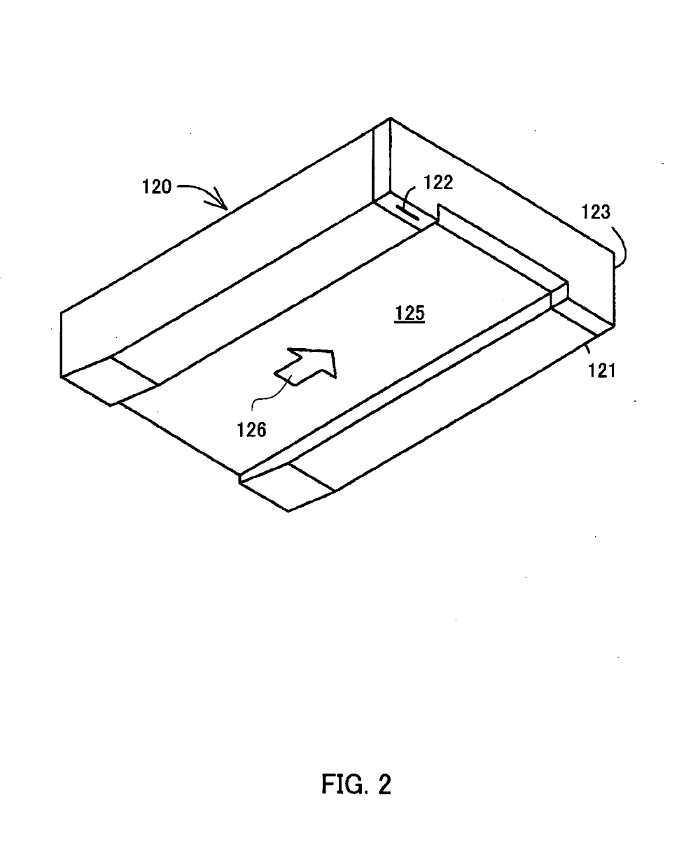

The slider 121 has an approximately rectangular parallelepiped shape, and is made of Al₂O₃—TiC (Altic). The slider 121 supports the head 122 and floats from the surface of the disc 104. The head 122 records information in and reproduces information from the disc 104. A surface of the slider 121 opposing to the magnetic disc 104 serves as a floating surface 125. The floating surface 125 receives airflow 126 that occurs with rotations of the magnetic disc 104. Here, FIG. 2 is a schematic perspective view of the magnetic head part 120.

The head 122 is, for example, a MR inductive composite head that includes an inductive head device that writes binary information in the magnetic disc 104 utilizing the magnetic field generated by a conductive coil pattern (not shown), and a magnetoresistive (“MR”) head that reads the binary information based on the resistance that varies in accordance with the magnetic field applied by the magnetic disc 104.

The suspension 130 serves to support the magnetic head part 120 and to apply an elastic force to the magnetic head part 120 against the magnetic disc 104, and is, for example, a stainless steel suspension. The suspension 130 has a flexure (also referred to as a gimbal spring or another name) which cantilevers the magnetic head part 120, and a load beam (also referred to as a load arm or another name) which is connected to the base plate 150. The load beam has a spring part at its center so as to apply a sufficient compression force in a Z direction. Therefore, the load beam has a rigid member at its proximal end, a spring member at its center, and a rigid member at its distal end.

A member that includes a magnetic head part 120, a suspension 130, and a base plate 150 is referred to as a head gimbal assembly (“HGA”).

The carriage 140 serves to rotate or pivot the magnetic head part 120 in arrow directions shown in FIG. 1, and includes a shaft 142, an FPC 143, and an arm 144.

The shaft 142 is inserted into a hollow cylinder in the carriage 140, and extends perpendicular to the paper plane of FIG. 1 in the housing 102. The FPC 143 provides a wiring part (a long tail part of the suspension 130) with a control signal, a signal to be recorded in the disc 104, and the power, and receives a signal reproduced from the disc 104.

The arm 144 is an aluminum rigid body that is rotatable around the support 142, and has a perforation hole 145. The perforation hole 145 extends from a position slightly apart from an HSA attachment portion (circular perforation hole) to a shaft area (which is a circular area around the shaft 142) in the longitudinal direction. The perforation hole 145 has an elongated shape near the center part of the arm 144, and perforates the front or back (or top or bottom) surfaces of the arm 144. The front or top surface of the arm 144 is, for example, the surface of the uppermost arm 144 shown in FIG. 1. The bottom or back surface of the arm 144 is a back of the front or top surface. The perforation hole 145 of this embodiment perforates the front and back surfaces of the arm 144 perpendicularly (parallel to the shaft 142 or perpendicular to the disc 104 plane), but the present invention is not limited to this embodiment. The extending direction of the perforation hole 145 may incline to the front and back surfaces of the arm 144.

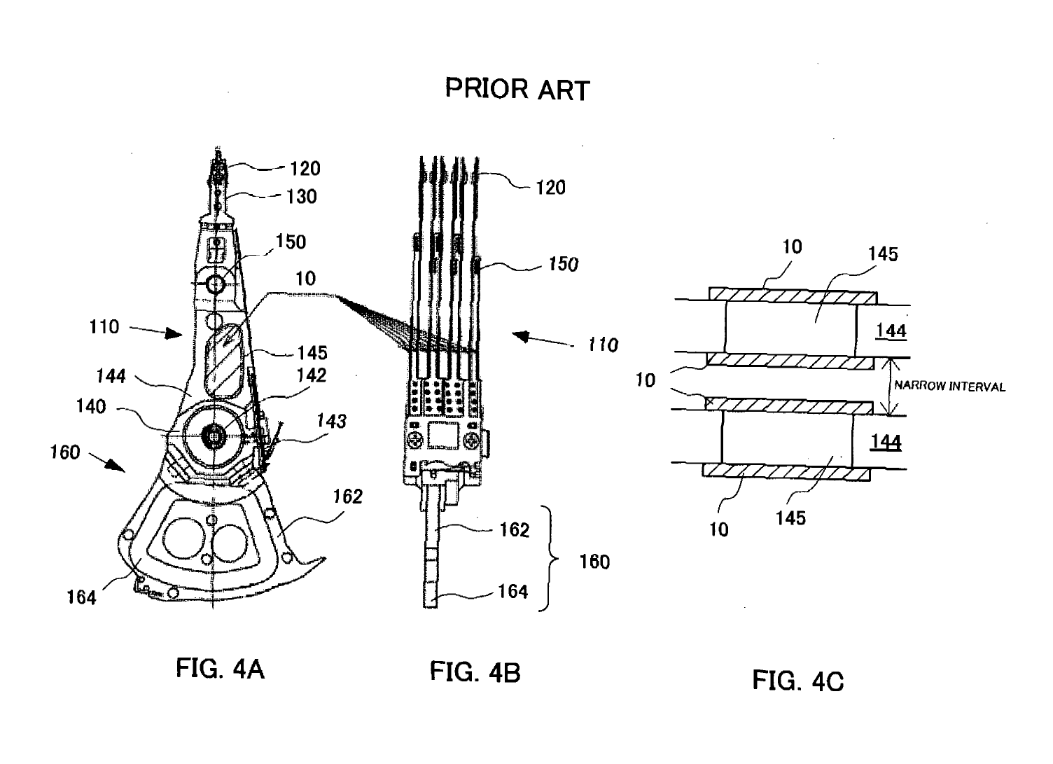

The perforation hole 145 is filled with resin 146, but the present invention is not limited to resin and may use a material lighter than aluminum. Conventionally, as shown in FIGS. 4A to 4C, metal plates 10 is manually adhered to the periphery of the perforation hole 145 on the front and back surfaces. Here, FIG. 4A is a plane view of the conventional HSA 110. FIG. 4B is a side view of the conventional HSA 110. FIG. 4C is a schematic enlarged section near the perforation hole 145 of the conventional arm 144. However, as shown in FIG. 4C, due to a narrow interval between a pair of adjacent arms 144, the attachments of the metal plate 10 are arduous, and the operability is bad. When the perforation hole 145 is not sealed, the airflow from the disc 104 enters the perforation hole 145 when the arm 144 rotates and vibrates the arm 144, causing the flutter of the disc 104, lowering the positioning accuracy of the head 122.

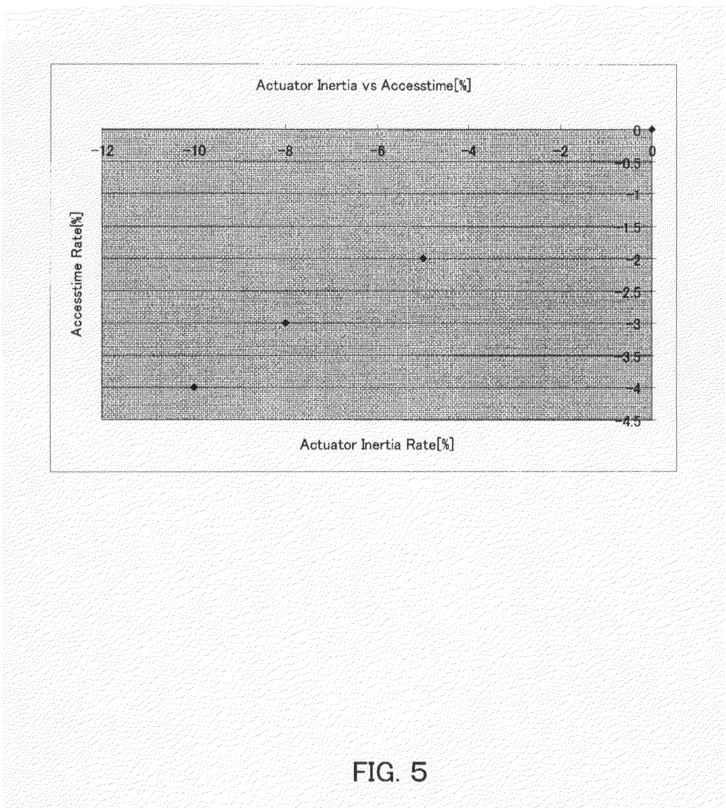

This embodiment fills the perforation hole 145 of the arm 144 with the resin 146, thereby preventing the vibrations of the arm 144 and the flutter of the disc 104, and maintaining the positioning accuracy of the head 122. The resin 146 is lighter than the metal plate 10, and the inertia moment of the arm 144 reduces and the head 122 can move quickly. FIG. 5 is a graph showing that an access time period for the head 122 to a target track becomes shorter as the inertia moment of the arm 144 reduces. The ordinate axis denotes the access time period, and the ordinate axis denotes the inertia moment.

This embodiment maintains the size and position of the perforation hole 145, and the number of perforation holes 145 of the conventional structure, but the present invention does not limit the structure of the perforation hole 145. The perforation hole 145 is provided depending upon a shape, a weight distribution, and the degree of the vibration of the arm 144. For example, when the perforation hole 145 provided outside the center of gravity of the arm 144 is effective to the reduction of the vibration of the arm 144, two perforations holes may be provided before and after the center-of-gravity position. Thus, when there are plural perforation holes, the prior art requires each perforation hole to be sealed with the metal plate 10. On the other hand, this embodiment can simultaneously seal plural perforation holes through one resin molding step, improving the operability as discussed later.

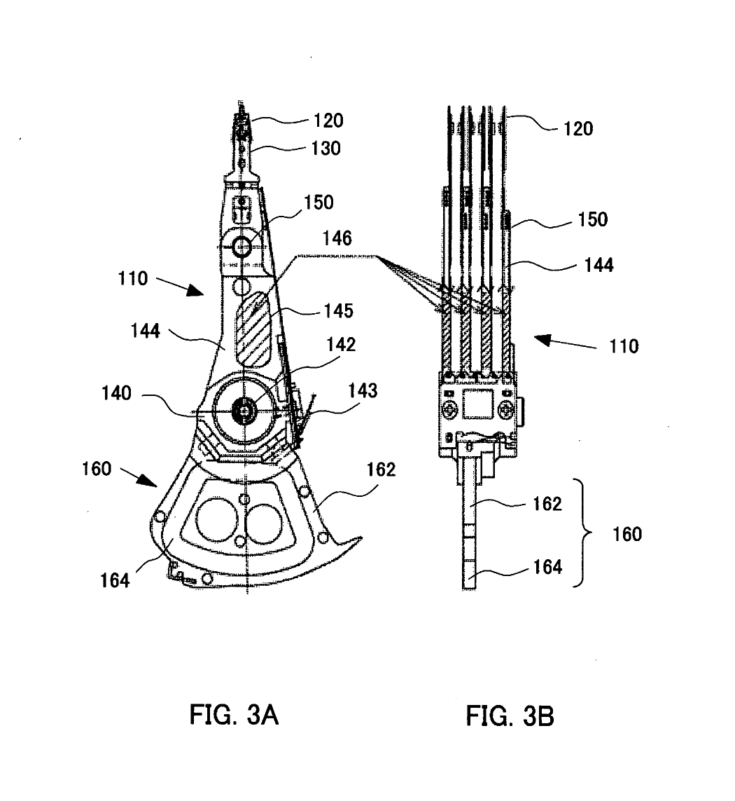

The VCM 160 includes, as shown in FIGS. 1, 3A and 3B, a coil block 162, a voice coil 164, a yoke 166, and a permanent magnet (not shown). Here, FIG. 3A is a plane view of the HSA 110. FIG. 3B is a side view of the HSA 110. While the carriage 140 drives six magnetic head parts 120 used to record information in and reproduce information from both sides of three discs 104 in these figures, the number of discs is not limited to three.

The coil block 162 is provided at an opposite side to the arm 144 with respect to the shaft 142 of the carriage 140, and serves as a support frame that supports the voice coil 164. The coil block 162 is integrally molded with resin around the voice coil 164. The voice coil 164 is located between a pair of yokes 166 fixed on the housing 102. In accordance with a value of the current that flows through the voice coil 164, the carriage 140 rotates around the shaft 142.

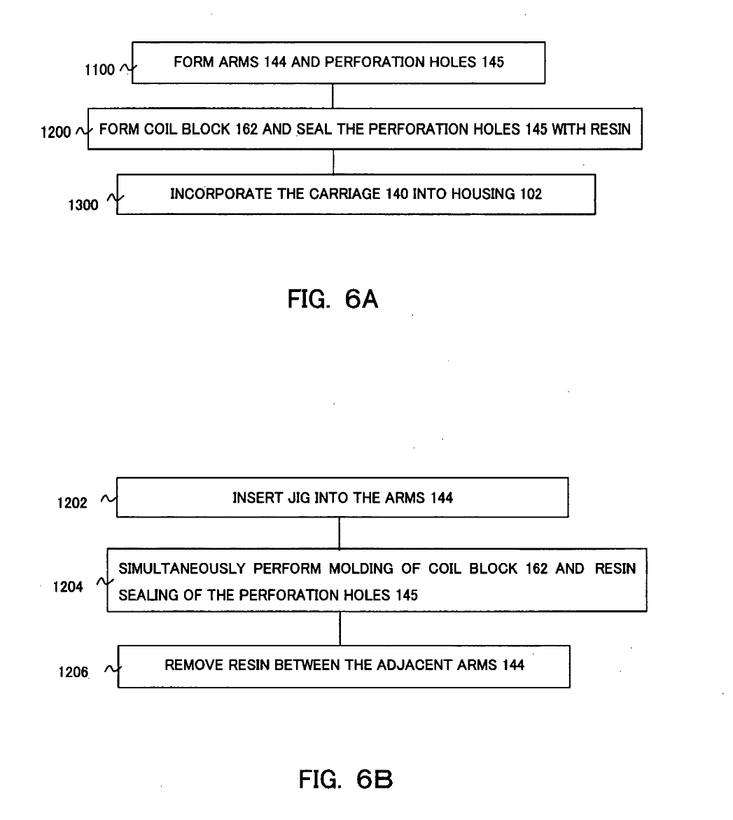

Referring now to FIGS. 6A to 8, a description will be given of a method for filling the resin 146 in the perforation hole 145 shown in FIGS. 3A and 3B. Here, FIG. 6A is a flowchart for explaining a principal part of a manufacturing the HSA 110 or the carriage 140 in this embodiment. Initially, the arms 144 and the perforation holes 145 are formed (step 1100).

Next, molding of the coil block 162 and resin sealing of the perforation holes 145 are performed (step 1200). Conventionally, molding of the coil block 162 and sealing of the perforation hole 145 with the metal plate 10 are manually conducted in different processes. On the other hand, this embodiment simultaneously and automatically performs them, thereby improving the operability and the throughput.

The step 1200 intends to use the same molding machine, and does not require molding of the coil block 162 and resin sealing of the perforation holes 145 to be simultaneously performed on the time fashion. However, this embodiment further improves the operability and the throughput by using these steps simultaneously, as described later. The conventional method manually seals with the metal plates 10, whereas this embodiment uses automatic filling. It is sufficient for the present invention to automate sealing of the perforation hole 145. This embodiment uses the same resin material to mold the coil block 162 and to seal the perforation hole 145.

Applicable resin is one suitable for a highly heat-resistant application and has good dimensional accuracy and stability, such as Super Enpla, crystalline plastic Polyphenylene Sulfide (“PPS”) and liquid crystal polymer (“LCP”). From the high heat-resistance demand, the continuous use temperature is preferably 200° C. or higher. From the high dimensional accuracy and stability, the mold shrinkage factor and coefficient of linear expansion are so small that a molded article has small warping, twisting and shrinking characteristics. A dimensional variation is preferable small to moisture absorption. The resin preferably maintains such a mechanical characteristic that it possesses high strength, high toughness, small reduction of its physical property at a high temperature, and high creep resistance. The resin preferably has such high flowability during molding that a wide variety of products can be injection-molded from a small thickness to a large thickness. The resin is preferably highly resistant to an alkali organic solvent, highly resistant to chemicals, and satisfies UL94V-0 standard without using fire retardant.

Referring now to FIG. 6B, a description will be given of an illustration of details of the step 1200. Initially, a jig or block (not shown) is attached to the arm 144 (step 1202). The jig (not shown) of this embodiment connects plural perforation holes 145 in a direction parallel to the shaft 142, makes the perforation hole 145 of the uppermost arm 144 open, and seals the bottom surface of the lowermost arm 144. As a result, when the resin 146 is filled through the perforation hole 145 of the uppermost arm 144 in a direction parallel to the shaft 142 or gravity direction, all the perforation holes and apertures between them are filled with the resin 146.

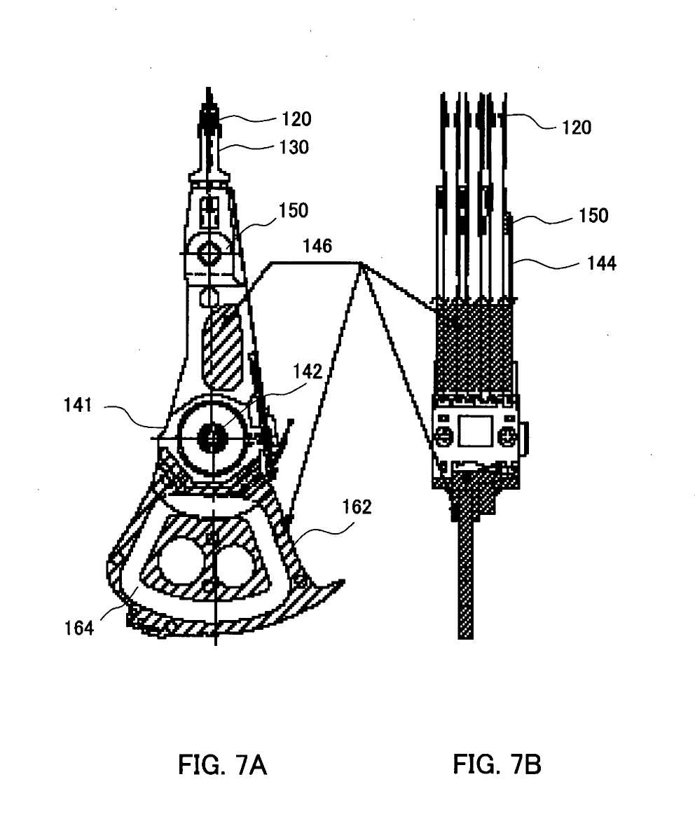

Next, molding of the coil block 162 and sealing of perforation holes 145 with resin are performed simultaneously (step 1204). The molding machine can use the conventional one used to mold the coil block 162, and does not need a new machine. FIGS. 7A and 7B show this state. FIG. 7A is a plane view of the state of the step 1204, and FIG. 7B is a side view.

The voice coil 164 may have an iron core and a mold coil. The mold coil is a coil in which the entire coil is sealed with resin for an improved insulation characteristic, molded into an approximately flat plate shape, and has an even thickness. In this case, the mold coil can be produced by the same molding machine.

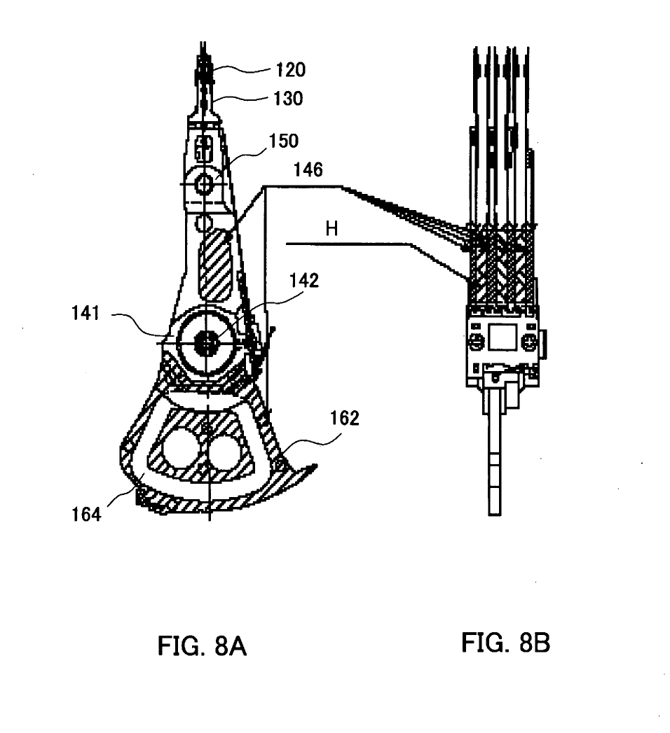

Next, the resin 146 between the adjacent arms 144 is removed (step 1206). FIGS. 8A and 8B show this state. FIGS. 8A and 8B are plane and side views of the step 1206. In FIG. 8B, hatched part H is part from which mold is removed through a cutting operation. One cutting operation can remove all the hatched parts H, and thus has improved operability.

Turning back to FIG. 6B, finally the carriage 140 is incorporated into the housing 102 and the procedure is completed (step 1300).

Another perforation hole (not shown) is provided in the tip of the arm 144. The suspension 130 is attached to the arm 144 via the perforation hole of the arm 144 and the base plate 150. The arm 144 has a comb shape when viewed from the side surface as shown in FIG. 3B.

The base plate 150 serves to attach the suspension 130 to the arm 144, and includes a welded section and a boss. The welded section is laser-welded with the suspension 130. The boss is a part to be swaged with the arm 144.

In operation of the HDD 100, the spindle motor 106 rotates the discs 104. The airflow associated with the rotations of each disc 104 is introduced between the disc 104 and slider 121, forming a fine air film and thus generating the floating force that enables the slider 121 to float over the disc surface. The suspension 130 applies an elastic compression force to the slider 121 in a direction opposing to the floating force of the slider 121. As a result, a balance between the floating force and the elastic force is formed.

The balance between the floating force and the elastic force spaces the magnetic head part 120 from the disc 104 by a constant distance. Next, the carriage 140 rotates around the shaft 142, providing the head 122's seek for a target track on the disc 104. The resin 146 is lighter than the metal plates 10, and reduces the inertia moment of the arm 144. Thus, the head 122 can quickly access the target track. In addition, the airflow does not enter the perforation holes 145, and does not cause the vibrations of the arm 144 and the flutter of the disc 104, maintaining the high positioning accuracy.

In writing, data from the host (not shown) such as a PC through an interface is modulated and supplied to the inductive head device. Thereby, the inductive head device writes down the data onto the target track. In reading, the MR head device is supplied with the predetermined sense current, and reads desired information from the target track on the disc 104.

Further, the present invention is not limited to these preferred embodiments, and various modifications and variations may be made without departing from the spirit and scope of the present invention.

Thus, the present invention can provide a carriage arm that can be easily manufactured and more quickly moved and a storage having the same.

What is claimed is:

1. A carriage arm that supports a head gimbal assembly that includes a head that records information in and/or reproduces the information from a recording medium, said carriage arm having a perforation hole near a center part, and said carriage arm comprising resin filled in the perforation hole.

2. A storage comprising:
a head gimbal assembly that includes a head that records information in and/or reproduces the information from a recording medium; and
a carriage that rotates around a shaft, and includes an arm that supports said head gimbal assembly, the arm having a perforation hole near a center part, and the perforation hole being filled with resin.

3. A storage according to claim 2, further comprising a voice coil motor that rotates said carriage, said voice coil motor including:
a coil block that is molded with the resin and opposes to the arm with respect to the shaft of the carriage; and
a voice coil mounted on the coil block.

4. A method for manufacturing a carriage for a storage, the carriage having an arm that supports a head gimbal assembly that includes a head that records information and/or reproduces the information from a recording medium, said method comprising the steps of:
forming a perforation hole near a center part in the arm; and
molding a coil block mounted with a voice coil of a voice coil motor that rotates the arm around a shaft and sealing the perforation hole with the same resin.

5. A method according to claim 4, wherein said molding and sealing step simultaneously performs molding of the coil block and sealing of the perforation hole.

6. A method according to claim 5, wherein the carriage includes plural arms, each of which has the perforation hole, and said molding and sealing step seals the resin in plural perforation holes and between the plural perforation holes, and
wherein said method further comprises the step of removing the resin between the plural perforation holes.
